(19) United States
(12) Patent Application Publication
(10) Pub. No.: US 2020/0294684 A1
(43) Pub. Date: Sep. 17, 2020

(54) ENHANCED PERFORMANCE ULTRACONDUCTIVE COPPER AND PROCESS OF MAKING

(71) Applicants: TE Connectivity Services GmbH, Schaffhausen (CH); TE Connectivity Germany GmbH, Bensheim (DE)

(72) Inventors: Martin W. BAYES, Hopkinton, MA (US); Tobias BECKER, St. Leon-Rot (DE); Marco WOLF, Hochstadt (DE); Shahrokh SANATI, Eggenstein-Leopoldshafen (DE); Gokce GULSOY, San Jose, CA (US); Yiliang WU, San Ramon, CA (US)

(21) Appl. No.: 16/816,493

(22) Filed: Mar. 12, 2020

Related U.S. Application Data
(60) Provisional application No. 62/817,118, filed on Mar. 12, 2019.
(60) Provisional application No. 62/817,108, filed on Mar. 12, 2019.
(60) Provisional application No. 62/817,102, filed on Mar. 12, 2019.

(51) Int. Cl. H01B 1/02; B32B 15/20; H01B 1/04

(52) U.S. Cl. CPC H01B 1/026; H01B 1/04; B32B 15/20

(57) ABSTRACT

The present invention relates to an enhanced performance ultraconductive copper composite structure. The ultraconductive copper composite structure comprises at least two composite layers in which the interface between the two composite layers is sufficiently close to the surface of the ultraconductive copper composite so as to enhance the RF conductivity of the ultraconductive copper composite. The present invention also provides for method of forming such a ultraconductive copper composite structure.

### CROSS REFERENCE TO RELATED APPLICATIONS

This non-provisional application claims the benefit under 35 U.S. Code § 119(e) of Provisional Application Ser. No. 62/817,118 filed Mar. 12, 2019 entitled ENHANCED PERFORMANCE ULTRACONDUCTIVE COPPER, Provisional Application Ser. No. 62/817,108 filed Mar. 12, 2019 entitled SYNTHESIS OF ULTRACONDUCTIVE METAL-CARBON COMPOSITES ON CYLINDRICAL SUBSTRATES and Provisional Application No. 62/817,102 filed Mar. 12, 2019 entitled REEL TO REEL PROCESS OF FORMING ULTRACONDUCTIVE METAL CARBON COMPOSITE WIRE AND TAPE AND USES THEREOF and whose entire disclosures are incorporated by reference herein.

### FIELD OF THE INVENTION

The present invention is directed to a composite structure with graphene and copper that has improved RF conductivity. Furthermore, the invention relates to a method of making such a composite structure having improved RF conductivity.

### BACKGROUND OF THE INVENTION

Copper is used for electrical and electronic purposes in the world as a cost-effective and reliable conductive material for many applications. Copper is only second to silver in its ability to conduct electricity. Substantial research efforts have been devoted to enhance the conductivity of copper by making composites of copper with carbon nanotubes or graphene to form ultraconductive copper. Ultraconductive copper has promises of enhanced electrical conductivity, higher strength and better thermal management characteristics. These research efforts have been focused on increasing the bulk (DC) conductivity of the ultraconductive copper or increasing its physical properties such as wear resistance. However, none of these efforts have been focused on improving the RF conductivity of the ultraconductive copper materials.

Furthermore, the production of ultraconductive copper composite wire and tape is problematic leading to non-uniform, unpredictable results which often times are not reproducible. In addition, the processing of such wire and tape is generally done in small batch processes with extremely low yields. Generally chemical vapor deposition is used in these batch processes to deposit or grow the carbon nanotubes or graphene. Furthermore, care must be taken to appropriately orient the grains of the underlying metal to enable growth of the carbon nanotube or graphene on the metal. Without such orientation, the growth of the carbon nanotube or graphene occurs randomly.

U.S. Patent Publication No. 2018/0330842 A1 describes a layered metal-graphene-metal nanolaminate electrical connector with improved wear performance and reduced friction. The electrical connector has a chemical vapor deposition monolayer graphene sheet sandwiched between two copper layers resulting in a decrease in the coefficient of friction and in improvement in wear resistance of an electrical contact.

U.S. Patent Publication No. 2018/0102197 A1 describes a composite structure having a copper layer and a first and second graphene layer that sandwiches the copper layer. The composite structure provides electron path tunnels between the copper layer and the first and second graphene layers. The electron path tunnels may enhance the bulk electrical conductivity. This publication also describes a multilayer composite structure which comprises a first copper layer, a first graphene layer on the first copper layer, a second graphene layer on the first graphene layer and a second copper layer on the second graphene layer.

The report, “Priority Research Areas to Accelerate the Development of Practical Ultraconductive Copper Conductors” by Lee and Burwell (ORNL/TM-2015/403) describes ultraconductive copper materials. The report states that many processes that are being developed to produce ultraconductive materials do not produce shapes for commercial applications, such as wires. The report further notes that use of carbon nanotubes in existing processes to produce wire has been unsuccessful due to separation of the carbon nanotube inclusions from the melt due to differences in carbon nanotube and copper densities resulting in inhomogenous distribution of the carbon nanotubes. The report also discusses combining ultraconductive copper synthesis with wire formation in a single process. According to the report, attempts have been made to deposit copper electrolytically into wire. The authors of the report question the viability of such a process due to the high process costs and necessary post processing treatment steps. The report does not address the enhanced RF conductivity of an ultraconductive copper material that is made into a cylindrical configuration.

U.S. Pat. No. 10,173,253 describes a method for the development of commercial scale nano-engineered ultraconductive copper wire. When forming ultraconductive wire, multi-walled carbon nanotubes are dispersed and de-agglomerated in hot metal. The multi-walled carbon nanotubes are dispersed in a precursor matrix via mixing and sintering to form a precursor material which is hot extruded multiple rounds at a predetermined temperature to form a nano-composite material. The nano-composite material is subjected to multiple rounds of hot extrusion to form a ultraconductive material which is then drawn to form an ultraconductive wire.

Chinese Patent Application No. CN 105097063A describes a high strength, high conductivity copper or copper alloy wire containing graphene. The wire includes a copper or copper alloy wire core containing a reinforcing phase and a graphene film grown on the outside of the wire core. The reinforcing phase is one or more of graphene, carbon nanotubes and ceramics.

Chinese Patent Application No. CN 102560415A discloses a three-dimensional graphene/metal wire or wire composite structure and the method of preparing such a structure. The metal wire or wire composite structure has a graphene coating having a diameter of 10 nm to 5000 microns and graphene layers from 1 to 100. This structure has good electrical conductivity and corrosion resistance.

It would, therefore, be beneficial to provide an ultraconductive copper composite having improved or enhanced RF conductivity, as well as processes to make such composites.

### SUMMARY OF THE INVENTION

An embodiment of the invention is directed to an ultraconductive copper composite having enhanced RF conductivity where the ultraconductive copper composite comprises at least two composite layers and an interface between one or more of the two composite layers sufficiently close to the surface of the ultraconductive copper composite to enhance the RF conductivity of the ultraconductive copper composite.

An embodiment is directed to an ultraconductive copper composite having enhanced RF conductivity where the composite comprises at least three composite layers. The three composite layers include a first composite layer with a first copper and a first graphene layer. A second composite layer has a at least a second copper layer which has a second graphene layer and a third graphene layer on each side of the second copper layer. A third composite layer has a third copper layer which includes a fourth graphene layer on the third copper layer. The three composite layers are stacked together so that the first graphene layer of the first composite layer abuts the second graphene layer of the second composite layer to form a first interface and the fourth graphene layer of the third composite layer lays against the third graphene layer of the second composite layer to form a second interface. At least one of the interfaces is sufficiently close to the surface of the ultraconductive copper composite so as to enhance the RF conductivity of the ultraconductive copper composite.

Another aspect of the invention is directed to a method to modify an ultraconductive copper composite where the ultraconductive copper composite comprises at least two composite layers having at least one interface between the two composite layers which is initially located too far below the surface of the ultraconductive composite to contribute to the RF conductivity. A sufficient amount of copper is removed from the external surface of the ultraconductive copper composite to bring one or more of the interfaces sufficiently close to the surface of the ultraconductive copper composite thereby improving the RF conductivity.

Another aspect of the invention relates to a method of forming an ultraconductive copper composite having enhanced RF conductivity where the composite has at least two composite layers. The method comprises forming a first graphene layer on a first layer of copper to form a first composite layer. A second graphene layer is formed on one side of the second copper layer to form the second composite layer. Chemical vapor deposition is preferably used to deposit the graphene on the first and second layer of the copper. The two composite layers are then stacked so that the first graphene layer of the first composite layer abuts the second graphene layer of the second composite layer to form a first interface. The interface is sufficiently close to the surface of the ultraconductive copper to increase its RF conductivity. The two composite layers are then hot pressed to form an ultraconductive copper composite having improved RF conductivity.

Another aspect of the invention relates to a method of forming an ultraconductive copper composite having enhanced RF conductivity where the composite has at least three composite layers. The method comprises forming a first graphene layer on a first layer of copper to form a first composite layer. A second and third graphene layer are formed on opposing sides of the second copper layer to form the second composite layer. A fourth layer of graphene is formed on a third copper layer to form the third composite layer of the ultraconductive copper composite. Chemical vapor deposition is preferably used to deposit the graphene on the first, second and third layer of the copper. The three composite layers are then stacked so that the first graphene layer of the first composite layer abuts the second graphene layer of the second composite layer to form a first interface and the fourth graphene layer of the third composite layer abuts the third graphene layer of the second composite layer to form a second interface. At least one of the interfaces is sufficiently close to the surface of the ultraconductive copper composite to increase its RF conductivity. The three composite layers are then hot pressed to form an ultraconductive copper composite having improved RF conductivity.

An aspect of the invention relates to a method of forming an ultraconductive metal-carbon composite on cylindrical substrates having enhanced RF conductivity.

Another aspect of the invention relates to a cylindrical conduit formed by the method of forming an ultraconductive metal-carbon composite on a cylindrical substrate having enhanced RF conductivity.

Yet another aspect of the invention relates to a reel to reel process of forming an ultraconductive metal-carbon composite wire or tape having enhanced RF conductivity.

Another further aspect of the invention relates to the use of wire having enhanced RF conductivity formed by the reel to reel process in other applications such as long cable wires.

A further aspect of the invention relates to the use of tape having enhanced RF conductivity formed by the reel to reel process in other applications such as electric motors and solenoids

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a schematic of a two layer ultraconductive copper composite having enhanced RF conductivity according to an embodiment of this invention.

FIG. 2 shows an alternate schematic of a two layer ultraconductive copper composite having enhanced RF conductivity.

FIG. 3 shows a schematic of a three layer ultraconductive copper composite having enhanced RF conductivity.

FIG. 4 shows a flow diagram illustrating a method to form an ultraconductive copper composite having at least two composite layers with enhanced RF conductivity.

FIG. 5 shows a flow diagram illustrating an embodiment of the method to form an ultraconductive metal-carbon composite having enhanced RF conductivity on a cylindrical conduit.

FIG. 6 shows a flow diagram illustrating an alternative embodiment of a method to form an ultraconductive metal-carbon composite having enhanced RF conductivity on a cylindrical conduit.

FIG. 7 shows a flow diagram illustrating yet another alternative embodiment of the method to form an ultraconductive metal-carbon composite having enhanced RF conductivity on a cylindrical conduit.

FIG. 8 shows a flow diagram illustrating yet another alternative embodiment of the method to form an ultraconductive metal-carbon composite having enhanced RF conductivity on a cylindrical conduit

FIG. 9 shows a flow diagram illustrating a reel to reel process for forming an ultraconductive metal-carbon composite wire and tape.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The present invention relates to a ultraconductive copper composite structure using copper and graphene which possesses improved RF conductivity over copper alone.

RF conductivity comes into play as a result of the attenuation due to finite metal conductivity. RF conductivity is significant in longer transmission lines, antennas and radio frequency and microwave circuits. The enhancement of RF conductivity would reduce losses allowing for the creation of longer transmission lines and improved selectivity resonator structures. The overall loss of most transmission lines is dominated by the metal loss at microwave frequencies. Metal loss is proportional to square-root of frequency. Metal loss is modeled by the R′ component in the transmission line model which is series resistance per unit length. The R′ component is a function of the geometry of the transmission line and the RF sheet resistance of the metal system that is used. The RF sheet resistance is generally greater than the DC sheet resistance due to skin effect. Skin effect is the tendency of high frequency current to be highest at the surface of the conductor and then decay exponentially toward the center or interior of the conductor, instead of flowing uniformly within the entire conductor. The higher the frequency, the greater the tendency for this to occur. The skin depth is defined as a depth used to approximate the effective cross-sectional area of a conductor when the skin effect is limiting that area. Therefore, to obtain improved RF conductivity at a desired frequency, the thickness of the outer copper layers(s) of any ultraconductive copper composite structure must be significantly less than the skin depth of copper at that frequency. For a composite structure produced using 30 micron copper foils such as the composite in US Patent Publication 2018/0102197, it would be expected that any enhancement of RF conductivity would be limited to frequencies well below the frequency (ca. 4.7 MHz) at which the skin depth of copper is 30 microns. At higher frequencies, the skin depth becomes progressively smaller. For copper, the skin depth falls to approximately 2 microns at a frequency of 1 GHz to about ca. 0.46 microns at 20 GHz. Producing layers of copper which are so thin is difficult since such layers are very fragile and difficult to handle in manufacturing situations. Locating a material with overall better conductivity near the surface of the composite also helps with the enhancement of the RF conductivity.

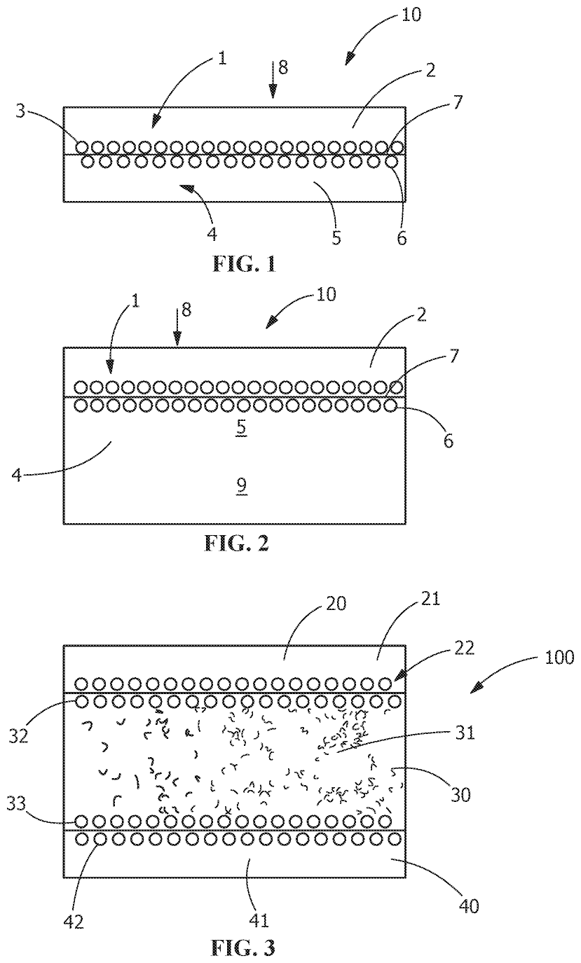

The present invention provides for a ultraconductive copper composite material of graphene and copper in which the ultraconductive copper composite has enhanced RF conductivity. In one embodiment of the invention, the utlraconductive copper composite 10 comprises at least two composite layers as shown in FIG. 1. The first composite layer 1 has a first copper layer 2 with a first graphene coating 3. The second composite layer 4 has a second copper layer 5 with a second graphene coating 6. The two composite layers 1, 4 are stacked together so that the first graphene coating 3 abuts the second graphene coating 6 to form a first interface 7. The first interface 7 is sufficiently close to the top 8 of the ultraconductive copper composite to improve the RF conductivity of the ultraconductive copper composite.

Graphene (GR) is a one atom thick two dimensional carbon material that is currently used in electrical, thermal and mechanical applications. The carbon atoms in graphene are covalently bonded in a honeycomb (hexagonal) lattice. Graphene is very thin and flexible, yet conductive. Any amount of graphene coverage or structure of graphene that will provide the desired enhancement of the RF conductivity in the end product can be used. In one embodiment, the graphene surface coverage can be approximately 95% of the surface of the composite layer. In another embodiment, the graphene surface coverage can be approximately 99% of the surface of the composite layer. In another embodiment, the graphene layer can be the additive resultant layer of graphene from each of the composite layers when stacked. In yet another embodiment, the graphene may be a graphene monolayer or a graphene bi-layer or a few layers of graphene provided that the layers maintain the properties of graphene. Although this invention is described for use with graphene, it is equally possibly applicable to inhomogenous copper-carbon nanotube structures which confer analogous improvements in bulk conductivity. One of ordinary skill in the art would be able to use the carbon nanotube structures in place of graphene.

The two composite layers of the ultraconductive copper composite all include a layer of copper. Copper can be obtained in various thicknesses. The first copper layer can be formed of copper, provided its thickness is less than the skin depth at the desired frequency, as a sufficiently thin copper layer is critical to enhance the RF conductivity. Additionally, the roughness of the exterior surface of the copper should be low, so as to minimize RF conductivity loss, preferably less than the skin depth over the frequency range of interest. Typically, copper foils below 5 microns are too fragile and cannot be handled as individual layers. In such instances, copper can be placed or deposited on a removable carrier substrate. Any removable carrier substrate can be used provided that it can mechanically tolerate the graphene deposition temperature; not interdiffuse with copper during processing in such a way to interfere with graphene growth, has a similar coefficient of expansivity to copper to limit distortion during temperature changes and is removable by a chemical or mechanical process, preferably one that would be selective to the carrier material. Preferably, the carrier substrate would have a thickness of at least 20 to about 30 microns. Suitable methods to place or deposit on a carrier substrate include electro-deposition, sputtering, laminating, rolling. U.S. Pat. No. 6,770,976 B2 describes an example of a method for forming a relatively thin release layer of copper on a carrier substrate and is incorporated herein by reference in its entirety. These methods are well known in the art and one of ordinary skill in the art can easily choose the best method to achieve the desired result. If a substrate is used with the copper, the substrate must be easily removable from the copper without damage to the copper itself.

The second copper layer 4 can be entirely copper or copper on a core layer. Examples of a core layer include copper nickel silicon alloy or stainless steel. FIG. 2 shows the embodiment of a two composite layers of the ultraconductive copper composite in which the second copper layer 4 includes a core layer 9 with copper 5.

If the thickness of the copper between the exterior surface and the first interface is too thick to achieve the enhanced RF conductivity at the desired frequency, then the thickness of the first copper layer can be reduced to fall below the skin effect at the desired frequency. Examples of methods used to reduce the thickness of the first copper layer and the third copper layers include chemical etching, electrochemical etching, uniform mechanical polishing or chemical mechanical planarization. EP Patent Publication Number 0342 669A2 provides an example of an etch method that can be used and is incorporated herein by reference. These methods are well known in the art and one of ordinary skill in the art can easily choose the method to use to reduce the thickness of the first copper layer to the desired thickness, while maintaining, or even improving, the smoothness of the final copper surface. Determining the appropriate thickness of the first copper layer of the first composite layer on the frequency of the end application would be well within the skill of one of ordinary skill in the art.

The first composite layer of the ultraconductive copper composite comprises a first copper layer and a first graphene layer. At least a part of the first copper layer used in this invention must have an appropriate crystallographic orientation. This first copper layer must also be thin enough to ensure that the RF conductivity is enhanced. Preferably, this first copper layer would be less than 2 microns if the ultraconductive copper composite was used in 1 GHz applications, or this first copper layer would be less than 21 microns if the ultraconductive copper composite was used in 10 MHz applications. A first graphene layer is deposited or grown on the first copper layer using chemical vapor deposition to form the first composite layer.

Chemical vapor deposition (CVD) can be used to deposit the graphene on the copper layers. CVD provides for growth of large areas of graphene that conform to the copper layer. CVD occurs in a hydrogen/argon atmosphere.

Methane is introduced as a precursor gas into a quartz tube so that the methane reacts to provide atomic carbon, which is deposited on the copper layer. The resulting graphene film is polycrystalline and may possibly have defects in the form of a one-dimensional grain boundary. CVD of the graphene may be conducted at temperatures from about 800° C. to about 1085° C. for about a period of 15 to about 45 minutes. Most preferably, the CVD is conducted at a temperature of about 900° C. to about 1085° C.

Alternatively, any other precursor gas such as ethylene, acetylene, ethane or propane can be used to provide atomic carbon to the copper layer. Furthermore, it is possible to use arc-evaporation and plasma enhanced CVD to deposit graphene on the copper layer. In one embodiment, the graphene layer is deposited on copper foil using CVD, plasma enhanced CVD, or arc-evaporation method in a roll to roll manner.

It is believed that the atomic spacing in the copper layer closely matches the graphene lattice constant, facilitating the growth of the graphene layer. The carbon atom lattice of the graphene film attached to the copper layer may promote the formation of an abundance of electron transfer tunnels. Hence, the electrical properties of the material are improved overall.

The second composite layer has a second graphene layer on one side of the second copper layer. The second graphene layer is deposited or grown on the second copper layer. The second graphene layer can be deposited using CVD.

Optionally, a thin layer of an organic or metallic material can be placed on any exposed surface of the composite to protect the copper layer from corrosion. An example of a metallic material is silver. If a metallic material is used to prevent the corrosion, it cannot compromise the conductivity of the composite.

This type of two layer ultraconductive copper composite can be used in sensors. In particular, the composite can be used in hybrid Nonius-based sensors, inductive sensors and magneto-inductive sensors. In each of these applications, a highly conductive layer is needed. Depending upon the desired frequency that the sensor will be used in, will ultimately determine the thickness of the first copper layer 2. For lower frequencies in the range of about 1 to about 10 MHz, the skin depth of copper should range from about 66 to about 21 microns. In this particular range, conventional copper foils can be used. If desired, to improve the conductivity, some of the copper from the conventional foils may also be removed as described below. At higher frequencies, the skin depth of the copper becomes increasingly smaller. Such thin copper layers are extremely fragile and commercially impractical. In such a case, a thicker copper foil is used which requires a sufficient amount of copper to be removed from the exterior surface of the ultraconductive copper composite so that the thickness of the copper between the external surface and the first interface falls well below the skin effect at the desired frequency. Examples of methods used to reduce the thickness of the copper include chemical etching, electrochemical etching, uniform mechanical polishing or chemical mechanical planarization. It is also desirable that the method used to reduce the thickness of the copper also reduces the roughness of the surface so as to further reduce electrical losses.

Determining the thickness of the copper in such a sensor is well within the skill of one of ordinary skill in the art.

In yet another embodiment, the ultraconductive copper composite 100 preferably comprises three composite layers. The first composite layer 20 includes a first copper layer 21 and a first graphene layer 22 on one side of the first copper layer 21. The second composite layer 30 has a second copper layer 31 with a second graphene 32 on one surface of the second copper layer 31 and a third graphene layer 33 on the opposing surface of the second copper layer 31. The third composite layer 40 includes a third copper layer 41 with a fourth graphene layer 42 on one side of the third copper layer 41.

The second composite layer 30 has two graphene layers 32 33, one on each side of the second copper layer 31. The thickness of this second composite layer 30 is well within the skill of one of ordinary skill in the art, so long as the second composite layer enables graphene growth on the layer. Preferably, the second copper layer 31 of the second composite layer 30 can provide some beneficial mechanical properties for the ultraconductive copper composite, while the ultraconductive copper composite still has improved RF conductivity. In one example, the second copper layer 31 is a thick layer of copper which provides for significant structural rigidity. Alternatively, a core layer with copper on both sides of the core layer is used for the second copper layer 31. An example of such a core layer includes a copper nickel silicon alloy or stainless steel. Graphene is then deposited on the both surfaces of the second copper layer 31 using CVD resulting in a second composite layer 30 for the ultraconductive copper composite 100.

The third composite layer 40 comprises a third copper layer 41 and a fourth graphene layer 42 on one side of the third copper layer 41. At least a part of the third copper layer 41 used in this invention must have an appropriate crystallographic orientation. This third copper layer 41 must also be thin enough to ensure that the RF conductivity of the ultraconductive copper composite 100 is enhanced. Preferably, this third composite layer 40 would be less than 2 microns if the composite was used in 1 GHz applications. A fourth graphene layer 42 is provided on the third copper layer 41 using chemical vapor deposition to form the third composite layer 40.

The first composite layer 20 is stacked with the second composite layer 30 so that the first graphene layer 22 of the first composite layer 20 abuts the surface of the second graphene layer 32 of the second composite layer 30. The third composite layer 40 is stacked on the opposite side of the second composite layer 30 so that the fourth graphene layer 42 of the third composite layer 40 abuts the third graphene layer 32 of the second composite layer 30. Any carrier materials for the first copper layer 21 and the third copper layer 41 are removed prior to use of the ultraconductive copper composite 100. The type of method used to remove the carrier material would be dependent upon the structure of the carrier itself, so long as the method does not damage the first copper layer 21 and the third copper layer 41 and can be easily determined by one of ordinary skill in the art.

Although a ultraconductive copper composite is described with at least two composite layers as well as three composite layers above, any multi-layer ultraconductive composite structure with as many layers as desired can be formed provided that the two outer composite layers of the structure are of the proper thickness of copper to provide for enhanced RF conductivity for the desired end application.

The present invention also relates to a method for forming a multilayer ultraconductive composite structure using copper and graphene that possesses improved RF conductivity over copper alone.

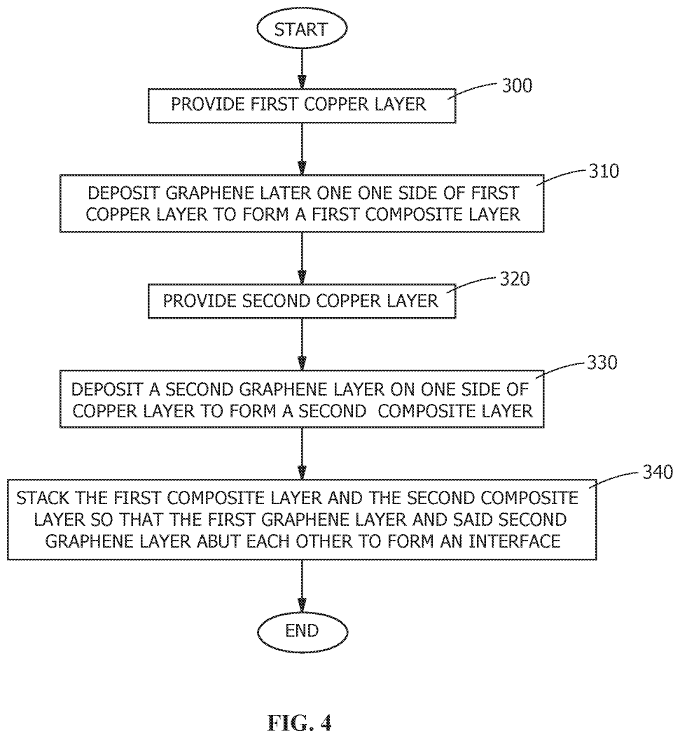

FIG. 4 is a schematic of the method for forming a multilayer ultraconductive composite structure according to the instant invention. First, a copper layer is provided 300. Preferably, the first copper layer is thinner than the skin depth at the desired frequency of use for the multilayer ultraconductive composite structure. In the next step, a first layer graphene is deposited on a first copper layer on one side of the first copper layer by use of chemical vapor deposition as described above to form a first composite layer 310. Then, a second copper layer is provided 320. A second graphene layer is deposited on a second copper layer using the chemical vapor deposition described above to form a second composite layer 330 in the next step.

After the chemical vapor deposition of the graphene, the first composite layer, and the second composite layer are stacked and assembled into a ultraconductive copper composite structure 340. The first graphene layer of the first composite layer is placed on the second graphene layer of the second composite layer so that the first graphene layer abuts the second graphene layer of the second composite layer and forms an interface. These layers are then hot-pressed. Hot-pressing may be performed at a temperature in the range of 800° C. to about 1000° C. Preferably, the three layers are hot pressed in a graphite mold at 900° C. for 20 minutes at 50 mPa argon atmosphere. Alternatively, any other method used to form the composite from the three layers can be used. Such other methods would be well within the skill of one of ordinary skill in the art.

The method shown in the schematic of FIG. 4 is not limited to the specific order set forth in the FIG. 4. For example, the various layers may have graphene deposited in a different order.

Another embodiment of the invention is also related to a method to modify an ultraconductive copper composite in which the composite layers are initially located too far below the surface of the ultraconductive copper composite for the composite layers to contribute to the enhanced RF conductivity. Any multilayer ultraconductive copper composite can be used in this method. For example, the two-layer, three-layer ultraconductive copper composites described above or the multilayer copper composite described in U.S. Patent Publication No. 2018/0102197 can be used. In the method of this invention, a sufficient amount of copper is removed from the external surface of the ultraconductive copper composite so that the thickness of copper between the external surface and the first interface falls well below the skin effect at the desired frequency. Determining this thickness of the external surface is well within the skill of one of ordinary skill in the art. Examples of methods used to reduce the thickness of the first composite layer include chemical etching, electrochemical etching, uniform mechanical polishing or chemical mechanical planarization.

The embodiments shown in the FIGS. 1-4 are shown schematically in the form of sheets, but the composite is not limited to sheets. In some embodiments, the composite may be a three-dimensional shaped object. The shaped object may be molded, machined, 3D printed or otherwise shaped to provide the desired shape.

The present invention relates to the synthesis of ultraconductive metal-carbon composites on a cylindrical substrate in which the cylindrical substrate possesses improved RF conductivity over cylindrical substrate itself. Preferably, the cylindrical substrate is used as a conductor in frequencies from about 0.5 MHz to about 60 GHz.

The method of the instant invention starts with a cylindrical substrate. Preferably, the cylindrical substrate is a conductor. The conductor can be any wire or bundle of wires having a desired thickness and electrical properties. Examples of suitable materials for the wire include copper, or any alloy thereof. Alternatively, the conductor can be any conductor material having an outer layer of copper. If such a conductor is used, the outer layer of copper can be coated, plated or clad onto the conductor. An example of such a conductor is copper clad stainless steel. The conductor is chosen to achieve the desired end result and can easily be determined by one of ordinary skill in the art.

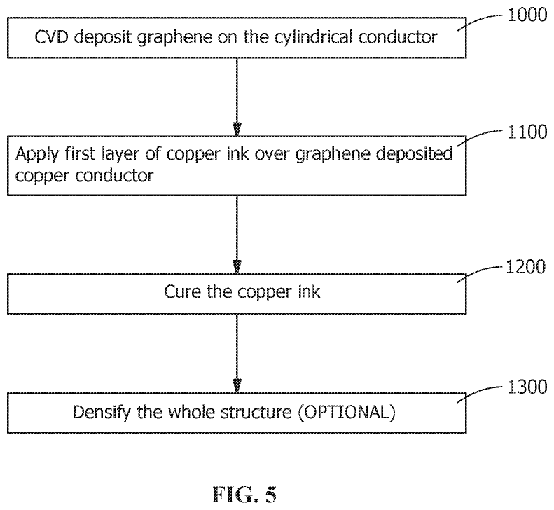

In an embodiment of the instant invention shown in FIG. 5, graphene is deposited on the conductor in the first step 1000. Any method to deposit or grown graphene on the conductor can be used. In the second step of the process 1100, a copper ink is applied to the conductor containing a graphene layer. Any coating technique or conductive ink printing technique can be used to apply the copper ink to the conductor. Coating techniques such as dip coating or spray coating are examples of the coating techniques that can be used in the instant invention. Any other coating technique known can also be used and would be easily used by one of ordinary skill in the art. Examples of conductive ink printing techniques include inkjet printing, pad printing, flexo, gravure, dispense jet, or aerosel jet printing. Any other conductive ink jet printing technique can be used and would be easily determined by one of ordinary skill in the art.

Any copper ink that provides a thin coating can be used. Depending upon the skin depth requirement, the coating thickness can be adjusted based upon the particle size, ink properties and printing technique to ensure that the RF conductivity of the conductor is improved. Copper inks generally are comprised of copper particles (0.01-10 μm) suspended in a mixture of organic solvents. Any copper ink having copper particles in the range of several nanometers to 10s of microns can be used. An example of a nanoparticle ink can be found in U.S. Pat. No. 10,047,236. By using a nanoparticle copper ink, one could achieve a high surface to volume ratio gas permeable layer that would possibly facilitate faster graphene growth as well as better coverage of the graphene. The ratio of the organic content of the ink to the solid filler should be less than 20:80. Most preferably, the ratio of the organic content of the ink to the solid filler should be 5:95. Alternatively, particle free copper inks can be used. process is the chemical vapor deposition process.

In the third step of the process 1200, shown in FIG. 5, the copper ink is cured. Examples of suitable curing methods that can be used include conventional heating, ultraviolet curing, infrared heating or photonic sintering/curing. Any curing method can be used provided that the desired results are obtained and would be well within the scope of one of ordinary skill in the art. This third step of curing can occur anywhere in the range of about 120° C. to about 800° C. The curing time for this step can take anywhere from a few seconds up to an hour to ensure that all the solvent is evaporated and any residual organic content is cured or possibly even partially or fully decomposed.

Another important consideration in reducing losses in transmission lines is the ability to control the surface roughness of the conductor. A discussion related to roughness can be found in U.S. Pat. No. 9,287,599, which is incorporated herein by reference. Depending upon the geometrical factor of the conductor and the ratio of the root mean square (“RMS”) of the surface roughness to the skin depth, attenuation in the transmission lines can be further increased by as much as a factor of 2. To minimize such losses, the roughness of this copper layer is preferably less than the skin depth over the frequency range of interest. Typical RMS roughness of a rolled annealed copper is 0.3 microns. Producing layers of copper with RMS roughness less than 0.3 microns would be ideal to effectively reduce losses. Most preferably, the copper layer would have an RMS roughness of less than 0.1 microns.

The entire structure can then be optionally densified in the next optional step 1300. Densification can be achieved by means of thermal processing, laser welding, e-beam welding, arc welding or solid-state ultrasonic welding. The type of method chosen for densification is well within the scope of one of ordinary skill in the art. The densified structure has a root mean surface roughness less than 0.3 μm, and preferably less than 0.1 μm.

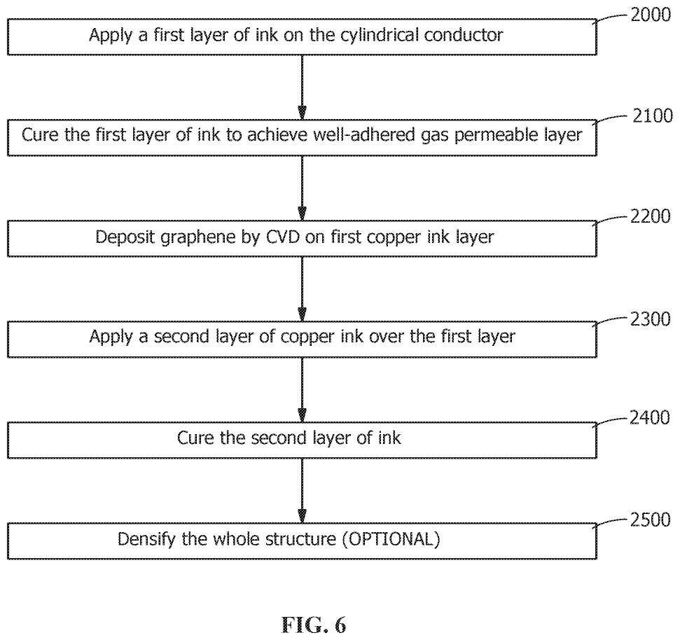

A flow diagram describing the further embodiment of this invention can be seen in FIG. 6. In this embodiment, a first layer of copper ink is placed on the cylindrical conduit 2000. Any copper ink that provides a thin coating can be used. Copper inks as described above are generally comprised of copper particles suspended in a mixture of organic solvents. The ratio of the organic content of the ink to the solid filler should be less than 20:80. Most preferably, the ratio of the organic content of the ink to the solid filler should be 5:95. Preferably, the copper ink layer in this embodiment is sufficiently permeable that the subsequent deposition of graphene enables simultaneous graphene growth both on top and underneath the surface of the copper ink.

In the second step of this embodiment 2100, the first layer of copper ink is cured to achieve a well-adhered gas permeable copper layer on the conduit. Any curing method can be used provided that the desired results are obtained and would be well within the scope of one of ordinary skill in the art. This second step of curing can occur anywhere in the range of about 120° C. to about 800° C. The curing time for this step can take anywhere from a few seconds up to an hour to ensure that all the solvent is evaporated and any residual organic content is cured or possibly even partially or fully decomposed. Alternatively, the first layer of copper ink can be cured during the next step.

In the third step of this embodiment 2200, graphene is deposited on the gas permeable copper layer. Any method to deposit or grown the graphene on the gas permeable copper layer can be used. Preferably, CVD is used. CVD of the graphene may be conducted at temperatures from about 800° C. to about 1085° C. for about a period of about 5 minutes to about 45 minutes.

In the fourth step of this embodiment 2300, a second layer of copper ink in then applied. Any copper ink described above can be used provided that the desired results are achieved.

Next, in the fifth step of this embodiment 2400, the copper ink is then cured. Any curing method can be used provided that the desired results are obtained and is well within the scope of one of ordinary skill in the art. Generally, this curing step occurs in the temperature range of about 120° C. to about 800° C. for about a few seconds up to an hour. Alternatively, this step is omitted, and the curing of the copper ink occurs at densification.

The final step of this embodiment is yet another optional step 2500. The entire conduit may optionally be densified. Densification can be achieved by means of thermal processing, laser welding, e-beam welding, arc welding or solid-state ultrasonic welding. The type of method chosen for densification is well within the scope of one of ordinary skill in the art.

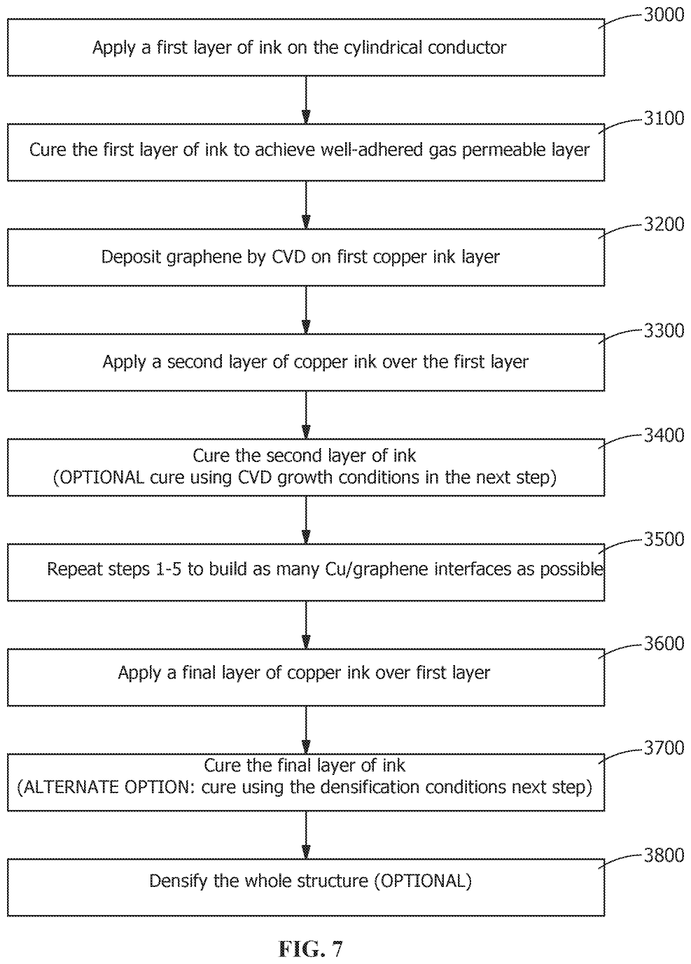

Yet a further embodiment of this method is shown in FIG. 7. In the first step of this embodiment 3000, a first layer of copper ink is placed on the cylindrical conduit. Any copper ink described previously can be used in this third embodiment.

The copper ink is then cured in the second step of this embodiment 3100. Any curing method can be used provided that the desired results are obtained and is well within the scope of one of ordinary skill in the art. Generally, this curing step occurs in the temperature range of about 120° C. to about 800° C. for about a few seconds up to an hour. The cured copper ink forms a gas permeable layer on the cylindrical conduit. Alternatively, this step may be omitted, and the first layer of copper ink can be cured during the subsequent step.

Graphene is then deposited on the gas permeable layer formed by the first layer of copper ink in the third step 3200 of the embodiment of FIG. 7 Any method to deposit or grown graphene on the gas permeable layer can be used. Most preferably, CVD may be used at a temperature of about 800° C. to about 1085° C. for about 15 to about 45 minutes.

A second layer of copper ink is then applied over the graphene in the next step 3300. Any copper ink described above can be used.

The second layer of copper ink is then cured in the following step 3400. Any curing method can be used provided that the desired results are obtained and is well within the scope of one of ordinary skill in the art. Generally, this curing step occurs in the temperature range of about 120° C. to about 800° C. for about a few seconds up to an hour. The cured copper ink forms a gas permeable layer on the cylindrical conduit. Optionally, the second layer can be cured using the CVD growth condition if additional copper/graphene layers are being added.

The steps set forth above can be repeated to obtain as many copper/graphene layers are desired or necessary to achieve the desired electrical properties of the cylindrical substrate 3500. Determining the appropriate number of copper/graphene layers needed to achieve the desired properties would be well within the skill of one of ordinary skill in the art. By using this method, one can ensure that the ultraconductive material on the conduit is close the surface of the conduit thereby enhancing the overall (DC) conductivity as well as the RF conductivity of the conduit. For the preferred frequencies that the conduit would be used, the skin depth is equal to or greater than the radius of the conduit. When the skin depth is less than the wire radius, preferably less layers would be needed to achieve the enhanced RF conductivity.

In the next step 3600 of the process of FIG. 7, a final layer of copper ink is placed on the conduit thereafter. The final layer of copper ink can then be cured as shown in FIG. 7 flow diagram 3700. Any curing method described above can be used. If the structure is to be optionally densified, this curing step may be omitted as the ink will be cured by the densification step.

The entire structure is then optionally densified 3800. Any of the methods described above for densification can be used in this process.

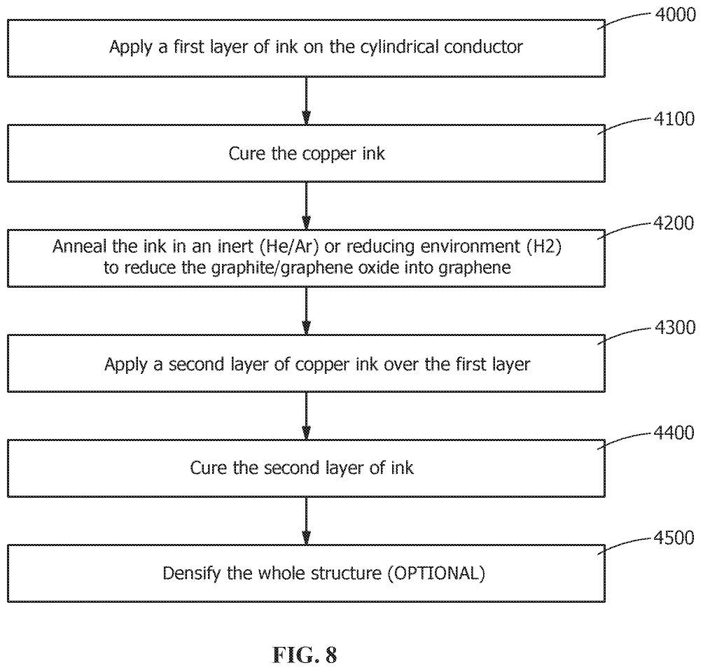

Yet a further embodiment of the instant invention can be found in FIG. 8. In this embodiment, a first layer of copper ink with graphite oxide/graphene oxide is placed on the cylindrical conduit 4000.

In the second step of the embodiment 4100, the copper ink is cured. Alternatively, this step can be omitted, and the copper ink cured during the next step in which the conduit is annealed.

In this embodiment, in the next step 4200, the cooper ink can be annealed in an inert environment or reducing environment to reduce the graphite/graphene oxide into graphene. Annealing can occur in an inert environment such as argon, helium or aluminum or titanium getter in a flowing argon or helium gas at temperatures from about 800° C. to about 1085° C. for a period of about 15 to about 45 minutes. Alternatively, the copper ink can be annealed in a reducing environment of hydrogen gas at a temperature from about 800° C. to about 1085° C. for a period of about 15 to about 45 minutes. One of ordinary skill in the art would be able to determine the parameters for the annealing process in view of the desired end result. It is believed that mixing the graphite/graphene oxide in the ink can enable the growth of graphene not just on the top surface of the copper ink but on any surface of the copper ink that is exposed to the graphite/graphene oxide. This enables the formation of multiple sub layers of graphene-copper interface, thereby enhancing the conductivity beyond a single continuous graphene/copper/graphene interface.

In this embodiment, a second layer of copper ink is then applied over the first layer 4300. Any copper ink described above can be used. The second layer of copper ink is then cured 4400. Alternatively, if the optional densification step is to be used 4500, then the second layer of copper ink can be cured during the densification process.

It is believed that the atomic spacing in the copper layer closely matches the graphene lattice constant, facilitating the growth of the graphene layer. The carbon atom lattice of the graphene film attached to the copper layer may promote the formation of an abundance of electron transfer tunnels. Hence, the electrical properties of the material are improved overall.

Another embodiment of the invention is also cylindrical conduit made using the any one of the alternative method of making an ultraconductive metal-carbon composite described above having improved RF conductivity. The cylindrical conduit has a conductor, an copper gas permeable overlay formed on the conductor due to the curing of copper ink placed on the conductor. The conductor also has a graphene layer deposited on the gas permeable copper layer. Additional layers of copper with graphene may be added. The number of layers can be determined by one of ordinary skill in the art so that the bulk (DC) conductivity as well as RF conductivity are increased. The cylindrical conduit can then be subject to optional densification process as described above.

The instant invention has been described with a cylindrical conduits. Any other shape or configuration for conduit can be used in place of a cylindrical configuration. Determining the appropriate configuration is well within the skill of one of ordinary skill in the art.

The present invention also relates to a continuous reel to reel process for forming an ultraconductive metal-carbon composite wire or tape which possesses improved RF conductivity. Preferably, the ultraconductive metal-carbon composite wire or tape is used at a frequency in the range of about 50 kHz to about 20 GHz. In addition, the invention relates to the use of such wire or tape in various applications.

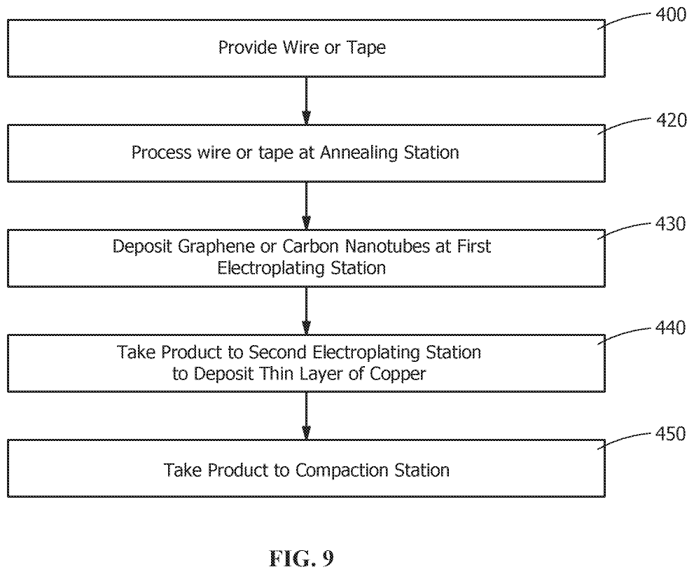

As shown in the flowchart of FIG. 9, the reel to reel process of the instant invention starts with a cylindrical substrate 400 The cylindrical substrate is preferably a metal wire. Examples of suitable wires include copper and silver alloys. Most preferably, the metal wire is a copper wire. Any other metal material can be used for the wire provided that it has the desired properties in the end product.

In the first step of the reel to reel process, the metal wire is processed at an annealing station 420. At this annealing station, the grains of the metal wire are oriented in order to obtain the desired crystal orientation to enhance carbon nanotube or graphene growth on the metal wire. At this annealing station, the desired crystal orientation on the surface of the metal wire can be obtained by annealing with a controlled cooling rate. Control of the cooling rate can be accomplished either by drawing the metal wire through an oven with a suitable temperature gradient and a given transverse rate or by use of a pulsed energy source such as by laser or electron beam. The conditions for this annealing station are well known and can easily be determined by one of ordinary skill in the art in order to obtain the desired crystal orientation on the metal wire to enhance the carbon nanotube or graphene growth.

In the second step of the reel to reel process, the metal wire is moved to an electroplating station 430. A carbon nanotube or graphene layer is applied to the metal wire. In this reel to reel process, the wire is drawn through the bath at a high speed to create the needed fluid shear through relative motion between the moving wire and the fixed bath. Preferably, additional fluid shear may be obtained by passing the wire though the center of a venturi nozzle which would increase the local fluid velocity. The size of the venturi nozzle can easily be determined by one of ordinary skill in the art to obtain the increase in the desired local fluid velocity.

Carbon nanotubes have hollow cylindrical nanostructures formed of carbon with typical diameters from 0.4 to 100 nm. Carbon nanotubes are composed of a single layer of carbon atoms in a cylindrical configuration. Their unique structure and spa chemical bonds are believed to impart superior electrical, mechanical and thermal properties to the material.

In the next step of the reel to reel process as shown in FIG. 9, the coated wire is moved to a second electroplating station 440. At this second electroplating station, an outer layer of copper is applied to the coated wire. Any known electroplating or electrodeposition process can be used. For example, the coated wire can be continuously fed into a tank containing an electrolytic solution comprising copper ions. A current is applied to the tank by any known method and an electrodeposited copper layer is deposited onto the wire having a graphene or carbon nanotube layer. The copper is preferably deposited into the wire for a sufficient amount of time to form the desired thickness of the outer copper layer. The coated wire can be used for any frequencies in the range of about 50 kHz to about 60 GHz. With this range of frequencies, the wire will have enhanced RF conductivity if the skin depth is equal to or greater than the radius of the original wire prior to processing. The time for depositing as well as the determination of the sufficient thickness to have enhanced RF conductivity can easily be calculated by one of ordinary skill in the art. As described above, an optional thin layer of an organic or metallic material can be placed on the copper layer to prevent corrosion of the copper.

It is believed that the reel to reel process of the instant invention promotes the formation of an abundance of electron transfer tunnels. Hence, the electrical properties of the wire are improved overall.

In the final step of the reel to reel process, the wire is moved to a compaction station 450. The compaction station can use either heat or pressure or both heat and pressure to consolidate the layers and to cause the carbon nanotubes and/or graphene to diffuse into the copper grains. Preferably, using the two separate energy sources, enables the necessary diffusion process to take place at a lower temperature and in less time than if thermal diffusion was used by itself. Using the two separate energy sources in such a manner reduces the tendency for the grain boundaries to lose the beneficial alignment which is achieved by the prior steps resulting in the overall improvement of the electrical properties of the wire.

Pressure can be applied by either drawing the wire through a die to slightly reduce its diameter through mechanical compression, or by passing it through an electromagnetic forming device. If the wire is passed through an electromagnetic forming device, magnetic energy applies a radial Lorenz force acting inwardly on the wire. An example of electromagnetic forming can be found at Fraunhofer Institute for Machine Tools and Forming Technology IWU at http://www.iw.fraunhofer.de, in a brochure, “Electromagnetic Forming” having a copyright of 2016, incorporated herein by reference in its entirety. In addition, the compaction station uses some heat.

The reel to reel process described above can be used for ultrasonic probe cables for ultrasonic probes. Ultrasonic probes consist of an array of sensors, each with its own driver and signal processing electronics. The processing hardware generates heat, so as to avoid excess heating of the probe that contacts the human body, the signals from the array are conveyed to the processing hardware through a cable bundle in which each signal in the array requires a separate wire. Wires formed according to the instant method would enable the construction of higher performance ultrasonic probe cables.

The reel to reel process described above can be used to form tapes. The tapes may optionally be subject to one additional compaction station. The properties for this final compaction station can easily be determined by one of ordinary skill in the art to achieve the desired final properties for the tapes. Tapes offer an increased surface to volume ratio over wires, which provides for better electrical performance than wires of equal volume. The tapes formed by the process of this invention can be easily used for electric motors and solenoids.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A ultraconductive copper composite with an outer surface comprising a first composite layer and a second composite layer, the said first composite layer and the said second composite layer having an interface between said first composite layer and said second composite layer wherein said interface is sufficiently close to said outer surface thereby enhancing the RF conductivity of said ultraconductive copper composite.

2. A ultraconductive copper composite of claim 1, wherein said first composite layer comprises a first copper layer and a first graphene layer.

3. A ultraconductive copper composite of claim 2, wherein said second composite layer comprises a second copper layer of copper and a second graphene layer.

4. A ultraconductive copper composite of claim 3, wherein said first copper layer is less than 2 microns thick when said ultraconductive copper composite is used in a 1 GHz application.

5. A ultraconductive copper composite of claim 3, wherein said first copper layer is formed from a copper foil which is then reduced in thickness by a process chosen from the group comprising chemical etching, electromechanical etching, uniform mechanical polishing or chemical mechanical planarization.

6. A sensor made from an ultraconductive copper composite with an outer surface comprising a first composite layer and a second composite layer, the said first composite layer and the said second composite layer having an interface between said first composite layer and said second composite layer wherein said interface is sufficiently close to said outer surface thereby enhancing the conductivity of the sensor.

7. A sensor of claim 6, wherein said sensor has a frequency of about 0.5 MHz to about 60 GHz.

8. A ultraconductive copper composite with an outer surface comprising: a first composite layer, a second composite layer and a third composite layer; said first composite layer having a first copper layer and a first graphene layer; said second composite layer having a second copper layer having a first side and a second side, the first side of the second copper layer having a second graphene coating and said second side of the second copper layer having a third graphene coating, said third composite layer having a third copper layer and a fourth graphene coating, wherein said first graphene layer of said first composite layer is placed against the second graphene layer of said second copper layer to form a first interface and said fourth graphene layer of said third copper layer is placed against the third graphene layer of said second copper layer to form a second interface, wherein said at least one of said interfaces is sufficiently close to the outer surface of the ultraconductive copper composite, thereby enhancing the RF conductivity of said ultraconductive copper composite.

9. A method of modifying an ultraconductive copper composite with an external surface having at least two composite layers, each of said composite layers having a copper layer and a graphene layer with an interface between said composite layers comprising removing copper from the composite layers to bring said interface close to the external surface of said ultraconductive copper composite thereby improving the RF conductivity of the ultraconductive copper composite.

10. A method of forming an ultraconductive copper composite having an outer surface with at least two composite layers, said ultraconductive copper having enhanced RF conductivity comprising: forming a first graphene layer on a first copper layer to form a first composite layer; forming a second graphene layer on a second copper layer to form a second composite layer; stacking said first composite layer and said second composite layer so that the first graphene layer abuts the second graphene layer to form an first interface, wherein said interface is sufficiently close to the outer surface thereby enhancing the RF conductivity of said ultraconductive copper composite.

11. A method of forming an ultraconductive copper composite having an outer surface and at least three composite layers, said ultraconductive copper having enhanced RF conductivity comprising: forming a first graphene layer on a first copper layer to form a first composite layer; forming a second graphene layer and a third graphene layer on a second copper layer to form a second composite layer; forming a fourth graphene layer on a third copper layer, the first graphene layer of the first composite is placed against the second graphene layer of the second composite and the fourth graphene layer of the third composite is placed against the third graphene layer of the second composite.

12. The method of forming an ultraconductive copper composite having an outer surface and composite layers, said ultraconductive copper composite having enhanced RF conductivity comprising composite layers, said composite layers including stacking composite layers, each having a copper layer with two opposing surface, a first outer composite layer having a copper layer and a second outer composite layer having a copper layer, depositing graphene on each of the two opposing surfaces of said copper layer of said stacking composite, depositing graphene on the copper layer of said first outer composite layer and said second outer composite layer, stacking the stacking layers together to form a stacked composite, said stacked composite having a first graphene outer layer and a second graphene outer layer, placing said first outer layer on a first side of the stacked composite so that the graphene layer on said first outer layer abuts the first graphene layer of said stacked composite, and placing said second outer layer on a second side of the stacked composite so that the graphene layer of said second outer layer abuts the second graphene layer of said stacked composite.

13. A method of making an ultraconductive metal-carbon composite comprising applying a first copper ink to a cylindrical conductor, curing the copper ink to obtain a gas permeable copper overlay on said cylindrical conductor, depositing graphene on said gas permeable copper overlay to form a graphene layer, applying a second copper ink over said graphene layer, curing said second copper ink, thereby enhancing the RF conductivity of said ultraconductive copper composite.

14. A method of making an ultraconductive metal-carbon composite comprising applying a first layer of copper ink onto a cylindrical conductor, curing the first layer of copper ink, annealing the first layer of copper ink to form a first graphene layer, applying a second layer of copper ink on said first graphene layer, curing said second layer of copper ink, thereby enhancing the RF conductivity of said ultraconductive copper composite.
